(19) United States
(12) Patent Application Publication
(10) Pub. No.: US 2020/0315208 A1
(43) Pub. Date: Oct. 8, 2020

(54) FROZEN CONFECTION COATING COMPOSITION WITH TWO STEP SOLIDIFICATION AND PROCESS FOR MANUFACTURING SAME

(71) Applicant: NESTEC S.A., Vevey (CH)

(72) Inventors: Joydeep Ray, Epalinges (CH); Olivier Schafer, Epalinges (CH); Laurence Sandoz, Echallens (CH); Shantha Nalur Chandrasekaran, Bakersfield, CA (US); Christel Webering, York North Yorkshire (GB)

(21) Appl. No.: 16/305,427

(22) PCT Filed: Jun. 1, 2017
(86) PCT No.: PCT/EP2017/063290

§ 371 Date: Nov. 29, 2018

(30) Foreign Application Priority Data
Jun. 2, 2016 (EP) 16172757.3

(51) Int. Cl. A23G 9/32; A23G 9/48; A23G 1/30; A23D 9/013; A23D 9/04

(52) U.S. Cl. CPC A23G 9/322; A23G 9/327; A23G 9/48; A23V 2002/00; A23D 9/013; A23D 9/04; A23G 1/305

(57) ABSTRACT

The invention relates to A frozen confection coating composition, the composition comprising, expressed in weight % based on the total weight of the coating, 35-75 wt. % of non-interesterified fat, preferably 40-65 wt. % of non-interesterified fat which comprises a fat blend of medium soft fat and liquid oil, and 25-65 wt. % of non-fat solids, preferably 35-60 wt. % of non-fat solids, wherein, the coating composition comprises, less than 35 wt. % of saturated fatty acid, preferably less than 30 wt. % of saturated fatty acids 15-50 wt. %, preferably 18-30% of monounsaturated fatty acid and less than 10%, preferably less than 5% of polyunsaturated fatty acid, and wherein the medium soft fat has above 40%, preferably between 50-70%, of solid fat content at 20° C., and medium soft fat has 54-60% of saturated fatty acid, and wherein the fat blend in the coating crystallizes in a first and second crystallization step at a temperature below −15° C. and displays a solid fat content of 30-50% within 2 min. of crystallization and a solid fat content of 40-70% after 60 min. of crystallization. The invention also relates to a process of making this composition and a frozen confection at least partly coated with the composition.

### FIELD OF THE INVENTION

The present invention relates to a composition for coating a frozen confection, in particular to a low SFA coating composition. The invention also relates to a method for coating a frozen confection.

### BACKGROUND

Coated frozen confections are products which are highly appreciated by consumers. Texture and nutritional profile of the coating is driver for consumer preference.

With the increasing concern for health and wellness there is an increasing need for reducing calories, sugars and fats also in frozen confections.

Chocolate-like or compound coatings based on vegetable fats are commonly used for coating frozen confection. The crystallization of the fats in a coating are a key contributor to the physical properties of a coating, in particular its textural properties (brittleness, melting) and setting time. Traditionally compound coatings for frozen confection have been manufactured with high proportions of lauric fats (e.g. coconut oil and palm kernel oil) which have a saturated fatty acid (SFA) level about 90%. With high amounts of lauric fats in the coatings, the SFA levels in the finished coating are typically between 30 and 60%.

Regarding fats the consumers are looking for products which are healthier but provide the same properties to the product. Solutions to this problem exist in the form of coatings blends comprising particular liquid oils which are lower in SFA and fractions of palm oil. The viscosity of these blends is important for achieving the SFA reduction because too viscous coating will result in more coating in the finished product and consequently a bigger quantity of SFA.

EP2099313 (Nestec) discloses an ice confection having an ice confection core and a snappy outer compound coating layer that has a reduced saturated fatty acid content. The fat in the compound coating is a mixture of fractionated palm oil and liquid oil. This compound coating has similar textural characteristics to that of conventional products, particularly ‘snappiness’. This coating provides advantages in terms of substantial SFA reduction. Nevertheless, there continue to be a need for further reduction of SFA.

EP2367441 (Unilever) discloses a composition for coating a frozen confection is provided, the composition comprising from 63-70 wt. % of a fat component comprising: 70-92 wt. % of a palm oil fraction or blend of fractions which contains at most 8 wt. % of S3 triglycerides and has a S2U: SU2 ratio of >2.5; 5-15 wt % of a liquid oil; and 0-15 wt % of cocoa butter. The terminology S and U denote the fatty acid residue in the triglycerides, wherein S is for saturated fatty acid and U stands for unsaturated fatty acids.

These characteristics refer to a combination of liquid oils and palm mid fraction, as stated in the application, namely Creamelt 900, Creamelt 700; containing >60% solids at 20° C. However, in order to achieve the right physical attributes of the coating, a higher fat content i.e. 63-70 wt. % comprising palm oil fraction or blend of fractions of at least 85 wt. % and 5-15 wt. % of a liquid oil is required. The application has limitations in regards to the amount of fat component and liquid oil necessary to be in a coating which in turn limits the overall SFA content and thickness of the coating.

Several prior art has used interesterified fats as a structuring agent to produce low saturated coating for confectionery products. Interesterification is a process to modify the physico-chemical properties of fats and oils such as, texture, mouthfeel, crystallization and melting behaviour. Interesterification involves an acyl-rearrangement reaction on the glycerol molecule in presence of chemical catalyst or enzymes. WO 2014/036557 A1 (Aarhus Karlshamn USA Inc.) discloses a low saturated fat composition for coating confectionery products, the composition comprising 24-35 wt. % of fat and 55-75 wt. % of non-fat solids, wherein the fat component comprises 35-80 wt. % of a structuring agent and 20-65% of liquid oil. The structuring agent comprises an interesterified blend of palm stearin and palm kernel stearin.

US 2011/008499 A1 (Akhane Akira [JP]) discloses a coating composition for confectionery products, the composition comprises an interesterified oil (A) that is non-selectively interesterified and contains 80 wt % or more of a fatty acid having 16 or more carbon atoms and 35-60 wt % of a saturated fatty acid having 16 or more carbon atoms in its constituent fatty acids, and an interesterified oil (B) that is non-selectively interesterified and contains 20-60 wt % of a saturated fatty acid having 12 to 14 carbon atoms and 40-80 wt % of a saturated fatty acid having 16 to 18 carbon atoms in its constituent fatty acids. The composition also included a tri-saturated fatty acid acylglycerol in a content of 10-15 wt %.

Further GB 2 297 760 A (Loders Croklaan BV [NL]) discloses a coating composition for confectionery products, the composition comprises at least 40% BOO triacylglycerides and displaying a solid fat content of N₃₀≥10 and having a major peak above 23° C.

The prior art described above requires the use of interesterified fats and oils as well as application of high melting lipid component to achieve physical functionalities (for e.g. crystallization speed and harder texture) of low saturated confectionery coatings. Also the prior art does not show how to further substantially reduce the SFA level in a coating composition for frozen confection.

There is a need to have coatings for frozen confections where the physical attributes of the coating meet the requirements of the parameters, e.g. dripping and setting time, pick-up weight, plastic viscosity and yield value without impact on coating breakage or bleeding.

Furthermore, there is a need for a reduced amount SFA in a frozen confectionery coating while maintaining the properties discussed above.

### OBJECT OF THE INVENTION

It is thus the object of present invention to provide a reduced SFA coating for frozen confectionery products said coating having physical properties acceptable for the consumers.

A second object the present invention is to provide a coating composition for frozen confectionery with acceptable processing characteristics.

### SUMMARY OF THE INVENTION

The present invention allows the production of low SFA compound coatings for frozen confection which exhibits good and comparable textural properties as traditional compound coatings containing significant amount of SFA. The low SFA fat blends developed in accordance with the current invention can achieve a SFA level from fat and oil additives that is reduced up to 50% compared to conventional compound coatings while maintaining snap properties. The coating composition according to the invention has an SFA level from fat and oil additives of less than 35% SFA by weight, compared to 35-60% by weight in regular frozen confection compound coatings.

The invention furthermore allows the SFA level to be reduced as low as 15-20% wt. SFA, still with satisfactory coating manufacturing, storage/handling and application of the coating.
According to a first aspect the present invention relates to a frozen confection coating composition, the composition comprising, expressed in weight % based on the total weight of the coating,
35-75 wt. % of non-interesterified fat, preferably 40-65 wt. % of non-interesterified fat which comprises a fat blend of medium soft fat and liquid oil, and
   25-65 wt. % of non-fat solids, preferably 35-60 wt. % of non-fat solids,
wherein, the coating composition comprises,
   less than 35 wt. % of saturated fatty acid, preferably less than 30 wt. % of saturated fatty acids
   15-50 wt. %, preferably 18-30% of monounsaturated fatty acid and
   less than 10%, preferably less than 5% of polyunsaturated fatty acid, and
wherein the medium soft fat has above 40%, preferably between 50-70%, of solid fat content at 20° C., and medium soft fat has 54-60% of saturated fatty acid, and
wherein the fat blend in the coating crystallizes in a first and second crystallization step at a temperature below −15° C. and displays a solid fat content of 30-50% within 2 min. of crystallization and a solid fat content of 40-70% after 60 min. of crystallization.

A preferred coating composition comprises the saturated fatty acid comprises between 12-24 C-atoms and the unsaturated fatty acid contains 16 C-atoms or more than 16 C-atoms.

It has surprisingly been found that the coating composition according to the invention can be used to coat frozen confection and performs well on the production line. Although it was expected that the solidification of the coating will be slower due to the larger amount of liquid oils added in the coating composition.

It has been found that the coating according to the invention meets the requirements of dripping and setting time, pick-up weight, plastic viscosity, yield value without impact on coating breakage or cracks.
In a second aspect the present invention relates to a process for manufacturing a coating composition according to any of the preceding claims, wherein said process comprising the steps:
   providing the non-fat solids, the medium soft fat and the liquid oil, melting the medium soft fat,
   mixing non-fat solids with the at least part of the melted medium soft fat and
   obtaining a mixture of medium soft fat and non-fat solids,
   refining the mixture of medium soft fat and non-fat solids by milling to reduce the size of particles, preferably to a particle size to below 40 microns, adding the liquid oil to the refined mixture and
   optionally adding emulsifier to the refined mixture and/or the mixture with the liquid oil.

The invention furthermore relates to a process for producing an at least partly coated frozen confection, and to an at least partly coated frozen confection with a coating as herein described.

### BRIEF DESCRIPTION OF DRAWINGS

FIG. 1 shows schematic diagram of the ‘two-step crystallization’ process in low SFA coating used for coating frozen confection.

FIG. 2 shows the evolution of Solid fat content of frozen confection coating fat blends with time, exhibiting different SFA content: (A) Blends of medium soft fat A with sunflower and high oleic sunflower oil (B) Blends of medium soft fat B with sunflower and high oleic sunflower oil, (C) Blends of medium soft fat C with sunflower and high oleic sunflower oil and (D) Blends of medium soft fat D with sunflower and high oleic sunflower oil. All the blends were crystallized isothermally at −15° C.

### DETAILED DESCRIPTION OF THE INVENTION

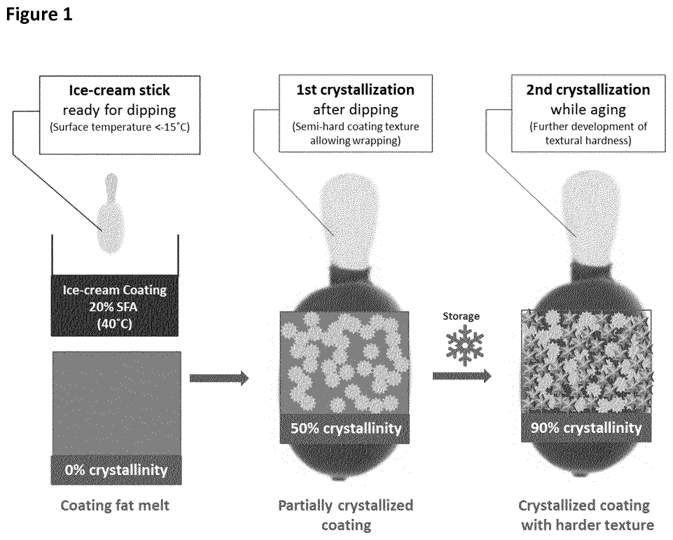

Advantageously, in accordance with the present invention it was found that liquid oils with high oleic content (>70%) (e.g. High Oleic Sunflower oil) can contribute to the structuring or development of fat crystal network leading to higher solid fat content which provides hard textural properties. This allows further reduction of amount of SFA in the fat blends without compromising the hardness or snap properties. As shown in FIG. 1, in the present invention coating composition, an initial crystallization step can be achieved at a very low SFA level (ie. 20%), which generates sufficient amount of solid fat content (˜50%) or crystallinity within 2 minutes of crystallization. Then the solid fat content or crystallinity of the coating can be further increased (about 85%) via a second crystallization step with adequate crystallization time. Surprisingly, it has been found that the early crystallization step would be sufficient enough to properly coat and wrap a frozen confection while the second crystallization step can occur as the frozen confection will continue to age in the storage units. So the frozen confection will be hard and provide similar snappiness like conventional high SFA coatings at the time of consumption.

Though the crystallization properties of liquid vegetable oils high in oleic content are known, structuring capabilities of the oils at subzero temperatures in a low SFA system are not. As described earlier, the textural properties of the coatings are mainly dependent on the crystallization/crystal packing of the medium soft fat and not from the liquid oils. Hence, generation of secondary fat crystal structure using liquid oil to improve the hardness or snap properties of the coatings has not been described previously. It is of real advantage, as with simple substitution of liquid oils having high oleic content, when blended with low SFA amounts in frozen confection compound coatings can generate crystal structure and textural hardness.

In the present context medium soft fat means that it has 40%, preferably 50-70% of solid fat at 20° C., and has 54-60 wt. % of saturated fatty acids.

In the present context the solid fat is measured using the ISO-8292-1D method.

In the present context a medium soft palm mid fraction is a fraction produced via two-stage fractionation of palm oil, which has at least higher than 40% of solid fat, preferably 50-70% of solid fat at ambient temperature i.e. about 20° C. and less than 5% of solid fat content above 35° C.

Further in the present context liquid oil means that the oil is liquid at ambient temperature i.e. about 20° C. and contain less than 5% of solid fat content at 0° C.

In the present context a “two step crystallization” means two different events of crystallization occurring with isothermal holding time at particular temperature. It has been found that the first step is primarily crystallization of the medium soft fats, while the second crystallization is primarily from the liquid oils, said crystallization is only obtained after a period of time.

In the coating composition according to the invention the composition comprises 35-75 wt. % of fat, which comprises a fat blend of medium soft fat and liquid oil. Below 35 wt. % of fat the coating with this composition will be very viscous and not processable whereas above 75 wt % of fat the coating will not give the consumers a pleasant eating experience.

With the coating composition according to the invention it is possible to obtain a coating which has less than 35 wt. % of SFA. Even coatings with less than 25 wt. % SFA may advantageously be made with the coating composition according to the invention. Also coatings with less than 20 wt. % of saturated fatty acids may be obtained. A preferred level of SFA in the coating composition is 25-30 wt. % of saturated fatty acids.

The coating composition according to the invention also comprises 15-50 wt. %, preferably 18-30% of monounsaturated fatty acid and less than 10 wt. %, preferably less than 5% of polyunsaturated fatty acid.

It is preferred that the composition according to the invention has a fat blend comprising 40-65 wt % of fat and 25-65 wt % non-fat solids, more preferably 30-60 wt % of non-fat solids. This range of fat content is preferred, as it contributes to achieve appropriate viscosity (along with addition of limited amount of emulsifiers) and preferred thickness of coating in frozen confections.

It is furthermore preferred that the fat blend of medium soft fat and liquid oil comprises 50-80 wt % of medium soft fat, more preferably 60-75 wt. % of medium soft fat, and 20-50 wt % of liquid oil, more preferably 25-40 wt. % of liquid fat oil based on the weight of the coating. With more than 50 wt. % of liquid oil the coating will have a low melting point and be softer resulting in less resistance against temperature fluctuation during transportation and faster melting in hand when consumed.

In the present context the particle size of the components may be may be determined with the laser diffraction technique (e.g. Malvern Mastersizer 2000, Malvern Instruments Ltd. UK or Sympatec Helos, Sympatec GmbH, Germany) using the Fraunhofer approximation.

The fat blend in the coating according to the invention crystallizes in a first and second crystallization step at a temperature of −15° C. and below. It has been found that the time between the first and second crystallizations can be regulated depending on the temperature. Lower the temperature; the faster is the second crystallization event (i.e. crystallization of the liquid triacylglycerols). Temperatures higher than −15° C. e.g. −10° C. are not suitable as it retards the second crystallization step of the blend and is close to the melting temperature of the liquid fraction in the fat blend (i.e. −5° C. to 5° C.). Temperature higher than −10° C. is also negatively affects the final textural properties of the coating.

It has been found that the fat blends according to the invention at a temperature of −15° C., displays a solid fat content of 30-50% within 2 min. of crystallization. Furthermore, a solid fat content is 40-70% after 60 min of crystallization.

Advantageously, the medium soft fat is selected from the group consisting of: Palm oil fractions, Shea butter fractions, Kokum Butter fractions, Sal Butter fractions, Cocoa Butter fractions where it includes soft stearin, mid and olein fractions or a combination thereof. In accordance with the invention the fat fractions are not interesterified.

In a preferred embodiment of the invention, the medium soft fat is medium soft palm mid fraction comprising 50-60 wt. %, preferably 54-60 wt. % of saturated fatty acid, C16 fatty acids which amount to more than 40% of the total fatty acids of the medium soft fat, displays above 40%, preferably between 50-70%, of solid fat content at 20° C., a melting point between 28-32° C., and has an iodine value (IV) of 36-48. The moderate amount of SFA present in the medium soft fats provides sufficient solid fat content after the ‘first step’ of crystallization of the compound coating. This in turn gives a mechanical resistance to the coatings during further processing (for e.g. wrapping and transportation).

Palm mid fractions are commercially available fat suppliers e.g. Cargill, AAK and Wilmar.

The medium soft fat can be obtained via fractionation of starting fat/oil or can be prepared via recombination of the soft stearin, mid and olein fractions.

The liquid oil may advantageously be selected from the group consisting of: high oleic sunflower oil, high stearic high oleic sunflower oil, high oleic safflower oil, high oleic soybean oil, high oleic rapeseed oil, high oleic canola oil, high oleic algal oil, high oleic palm oil, high oleic peanut oil, olive oil, macademia nut oil, moringa oleifera seed oil, hazelnut oil, avocado oil or a combination thereof.

In a particular preferred embodiment of the invention the liquid oil is high oleic sunflower oil, high oleic soybean or high oleic rapeseed oil such as high oleic canola oil comprising above 70%, preferably above 80% of monounsaturated fatty acid, below 10%, preferably below 5% of polyunsaturated fatty acid, in the liquid oil, displaying below 5% of solid fat content at 0° C., and wherein the unsaturated fatty acid contains 16C-atoms or more than 16C-atoms. Higher content of monounsaturated fatty acid (i.e. fatty acid with one double bond) in oils increases the oil melting temperature (−5° C. to 5° C.) which in turn allows the oil to solidify while providing a crystalline structure that develops around −15° C. and below. Higher amount of polyunsaturated fatty acids (i.e. fatty acid with more than one double bond) in oils lead to decrease the overall melting temperature (below −20° C.), hence do not crystallize at higher temperatures.

The coating composition according to the invention comprises 25-65 wt. % non-fat solids. The non-fat solids are preferably selected from the group consisting of: sugar, fibres, cocoa powder, milk powder, emulsifier and one or more flavours. The non-fat solids provide structure, flavour and colour to the coating.

In the present context the fat phase includes the in cocoa powder and milk powders. The fat in these powder are calculated in to the amounts of fat in the composition.

In a preferred embodiment of the invention the composition comprises 35-75 wt % fat comprising a blend of 15-60 wt % medium soft fat and 5-40 wt % liquid oil, 20-40 wt % sugar, 0-20 wt % cocoa powder, and 0-20 wt % of non-fat milk solids.

According to the present invention, the composition may comprise 0.1-2 wt. % of emulsifiers selected from sunflower lecithin, soya lecithin, polyglycerol polyricinoleate (PGPR; E476), ammonium phosphatide (YN; E442) or a combination thereof.

For chocolate flavoured coating the amounts of cocoa solids (11% fat) in the coating composition is below 20 wt. %, preferably from 0-15 wt. %, more preferably from 10-20 wt. %. For milk chocolate flavoured coating it is preferred that the amount of no-fat milk solids for milk chocolate is below 20 wt. %, preferably from 0-12 wt. %. To obtain other coatings no cocoa powder might be included at all.

A composition according to the invention may further comprise a structuring agent in an amount sufficient to provide strength and faster crystallization kinetic properties to the coating. The structuring agent may be an agent selected from the group consisting of a monoacylglycerol, diacylglycerol, monoacylglycerol ester, sorbitan fatty acid ester, waxes, behenic acid, palm stearin, and sucrose ester or a combination thereof. It is preferred that the structuring agent is present in an amount of between about 0.2% and 3% by weight of the coating.

In particular preferred composition according to the invention, the coatings developed comprises a medium soft palm oil fraction, low SFA liquid oil and optionally, a structuring agent.

Solids are preferably fillers such as fillers selected from the group selected from the group consisting of: sugar, fibers, cocoa powder, milk powder, emulsifier and one or more flavours.

Even with use of high amount of low SFA oil in the coating formulations, the medium soft fat fraction is sufficient to allow proper application on coated frozen confections. Contrary to the flexible coating obtained by previous art (e.g. as described in EP0783250B1), with the present invention a hard texture is obtained by making use of the slow crystallization properties of the low SFA oil high in monounsaturated fatty acid during aging in the storage freezer. This ensures to deliver harder texture when consumed.

Balance in proportion of liquid oil in the compound coatings is required in order to provide the hard texture and melt behaviour compatible with frozen confection consumption by consumer.

The composition according to the present invention may be combined with known techniques to reduce the fat and SFA (saturated fatty acid) content of chocolate containing coating: EP2099313 (Nestec), and EP2367441 (Unilever). These patents neither address the problem of reducing the amount of SFA below 30% in compound coatings while maintaining the absolute quantity of fat.

Fat and sugars are homogenously mixed within the composition for coating a frozen confection. Solidification step of said composition is related to the crystallization of fat phase. Crystallization of fat phase will be influenced by the presence of other molecules, and any modification in the composition may have an influence on this crystallization/solidification step. Texture (snap or brittleness) of the coating of a frozen confection may be considered as a driver for consumer preference, therefore it is important to maintain this characteristic.

Advantageously the coating composition comprises 35 to 75 wt. % fat, the fat component comprising a blend of 40-80 wt % of medium soft fat, preferably 50-80 wt % of medium soft fat, more preferably 60-75 wt % of medium soft fat, and 20-60 wt % of liquid fat, preferably 20-50 wt % of liquid fat, more preferably 25-40 wt % of liquid fat based on the weight of the total fat blend, 20-40 wt. % sugar, 0-20 wt. % cocoa powder, and 0-20 wt. % of non-fat milk solids.

In one particular preferred embodiment of the invention, the liquid oil is high oleic sunflower oil. The sunflower is particularly suitable in the scope of the present invention because they have a low SFA content, no off flavour when fresh and are reasonably priced.

Furthermore, the composition according to the present invention may in a preferred embodiment comprise from 0-20 wt. % non-fat milk solids in a milk containing coating. Below 1% non-fat milk solids, the colour, flavour and texture of the composition is not satisfactory from a sensory point of view. Above 20% non-fat milk solids, no additional benefit is achieved. For dark coating milk component may not be present.

In another embodiment the invention relates to a process for producing a coating composition according to any of the preceding claims, wherein said process comprising the steps: providing the non-fat solids, the medium soft fat and the liquid oil, melting the medium soft fat, mixing non-fat solids with the at least part of the melted medium soft fat and obtaining a mixture of medium soft fat and non-fat solids, refining the mixture of medium soft fat and non-fat solids by milling to reduce the size of particles, preferably to a particle size to below 40 microns, adding the liquid oil to the refined mixture and optionally adding emulsifier to the refined mixture and/or the mixture with the liquid oil.

In an alternative process of the invention the non-fat solids can be pre-milled in a separate process-step (e.g. by the use of air-classifier mills). The pre-milling step can then fully or partly replace the refining of the mixture of medium soft fat and non-fat solids by milling to reduce the particle.

In a further embodiment the invention relates process for producing an at least partly coated frozen confection, the process comprising providing a coating composition as described herein according to the invention and coating a frozen composition.

The invention also relates to a frozen confection at least partly coated with a composition to the invention.

Preferably, the frozen confection according to the present invention may have a coating thickness from 0.5 to 5 mm.

Furthermore, the frozen confection according to the present invention may be ice-cream.

### EXAMPLES

By way of example and not limitation, the following examples are illustrative of various embodiments of the present disclosure.

Fat Analysis:

Fats were Analysed with Standard Methods:

The fatty acid composition was done using Gas Chromatography, IUPAC method 2.304. The fatty acids are expressed as % fatty acids based on fat. For fat blends the fatty acids of each fat was determined and then tabulated mathematically to arrive at the blend composition.

The solid fat content was determined using pulsed NMR (Nuclear Magnetic Resonance), Minispec mq20 NMR Analyzer, Bruker Biospin GMBH (Rheinstetten, Germany) using ISO-8292-1D method, non-tempered and with slight modification in time as mentioned below. Supplier standards which had solids at 0%, 31.1% and 72.8% solids were used to calibrate the equipment.

Approximately 2 g of well melted fat was placed in a 10 mm NMR tube; samples were then pre-treated prior to testing to make sure it is fully melted. The fats were not tempered, heated to 60° C., and analyzed. Samples were held at 30 min at various temperatures (0, 10, 20, 25, 30, 35, 37 and 40° C.), and the values at each temperature was read in the NMR. Samples were run in duplicates, and the values were averaged. Isothermal crystallization was carried out at −15° C. Samples were maintained at −15° C. in the water bath and then transferred to NMR and solid fat content was recorded manually at defined intervals.

In the following the saturated fatty acids indicated are those in the fat blend expressed as % of total fatty acids in the fat blend.

Particle Size Measurements:

The particle size of the non-fat components in the coatings was determined with the laser diffraction technique (e.g. Malvern Mastersizer 2000, Malvern Instruments Ltd. UK or Sympatec Helos, Sympatec GmbH, Germany) using the Fraunhofer approximation.

For the measurement approximately 0.2 g (±0.02 g) of the homogeneous sample are weight into a 50 ml Erlenmeyer flask. 20 ml (±2 ml) of a medium chain triglyceride oil (e.g. Akomed R from AAK) are added. The sample is dispersed by application of ultrasound for 2 minutes and then slowly poured into the sample unit until the optimal obscuration of 20% (±5%) is obtained.

The results are expressed in μm at 10 (D₁₀), 50 (D₅₀) and 90% (D₉₀) of the cumulative undersize fraction. In the present invention the particle size values are defined as D₉₀.

Rheology Measurements:

Flow properties of the coatings have been evaluated using a Physica MCR 501-Anton Paar (Germany) Rheometer equipped with a CC27S geometry (Serial Number: 20689). Measurements have been performed at 40° C., applying shear rates within the range 2 to 50 s-1. Viscosity data is calculated from shear stresses measured throughout the shear rate range. Yield stress value was calculated dividing value of the stress at 5 s-1 (ramp up) by 10 expressed in Pascal [Pa]. Plastic Viscosity Value was calculated by multiplying of the viscosity at 40 s-1 (ramp up) by 0.74 expressed in Pascal second [Pa·s]

Dripping/Setting Time and Pick-Up Weight Measurements:

The coatings were completely melted and equilibrated at dipping temperature of 40° C. Temperature of the coatings were repeatedly monitored before dipping each commercial uncoated frozen confections. The surface temperature of the frozen confections were between −13° C. and −15° C. The time taken for the dripping of the coatings to stop was noted as driptime for each coating recipe.

After dripping of the excess coatings, setting time of the coatings were calculated by touching coated surface of the frozen confections wearing nitrile hand gloves. Inspection was carried until no traces of the compound coatings were observed to adhere on the gloves. These holding times were recorded as the setting time for particular coating recipes. The pick-up weight of the coatings were recorded via the decrease in weight of the total coating mass after dipping of each frozen confections.

### Example 1

Fat compositions (Fat blend 1-8) were prepared by blending Medium soft fat A & Medium soft fat B (Table 1) with Sunflower oil and High Oleic Sunflower oil (Table 2) as described below,

TABLE 1

Samples

| | Medium soft | Medium soft |
|---|---|---|
| Specifications | fat A | fat B |
| Slip melting point (° C.) | 29 | 32 |
| Iodine value (gI2/100 g) | 45 | 38 |
| Saturated fatty acids (%) | 54 | 60 |
| Monounsaturated fatty acids (%) | 38 | 34 |
| Polyunsaturated fatty acids (%) | 8 | 6 |
| Solid fat content (%) | 20° C. - 45 | 20° C. - 70 |
| | 25° C. - 20 | 25° C. - 40 |
| | 30° C. - 6 | 30° C. - 8 |
| | 35° C. - <1 | 35° C. - <1 |

TABLE 2

| | Fatty acids (%) | | |
|---|---|---|---|
| Samples | Saturated | Monounsaturated | Polyunsaturated |
| Sunflower oil | 10 | 20 | 70 |
| High Oleic | 8 | 81 | 11 |
| Sunflower oil | | | |

Fat blend 1=80 wt. % of Medium soft fat A+20 wt. % of Sunflower oil

Fat blend 2=80 wt. % of Medium soft fat A+20 wt. % of High Oleic Sunflower oil

Fat blend 3=59 wt. % of Medium soft fat A+41 wt. % of Sunflower oil

Fat blend 4=59 wt. % of Medium soft fat A+41 wt. % of High Oleic Sunflower oil

Fat blend 5=71 wt. % of Medium soft fat B+29 wt. % of Sunflower oil

Fat blend 6=71 wt. % of Medium soft fat B+29 wt. % of High Oleic Sunflower oil

Fat blend 7=52 wt. % of Medium soft fat B+48 wt. % of Sunflower oil

Fat blend 8=52 wt. % of Medium soft fat B+48 wt. % of High Oleic Sunflower oil

Fatty acid composition of the samples Fat blend 1-8 is summarized in Table 3.

TABLE 3

| | Fatty acids (%) | | |
|---|---|---|---|
| Samples | Saturated | Monounsaturated | Polyunsaturated |
| Fat blend 1 | 45 | 34 | 21 |
| Fat blend 2 | 45 | 47 | 8 |
| Fat blend 3 | 35 | 31 | 34 |
| Fat blend 4 | 35 | 56 | 9 |
| Fat blend 5 | 45 | 30 | 25 |
| Fat blend 6 | 45 | 48 | 7 |
| Fat blend 7 | 35 | 27 | 38 |
| Fat blend 8 | 35 | 57 | 8 |

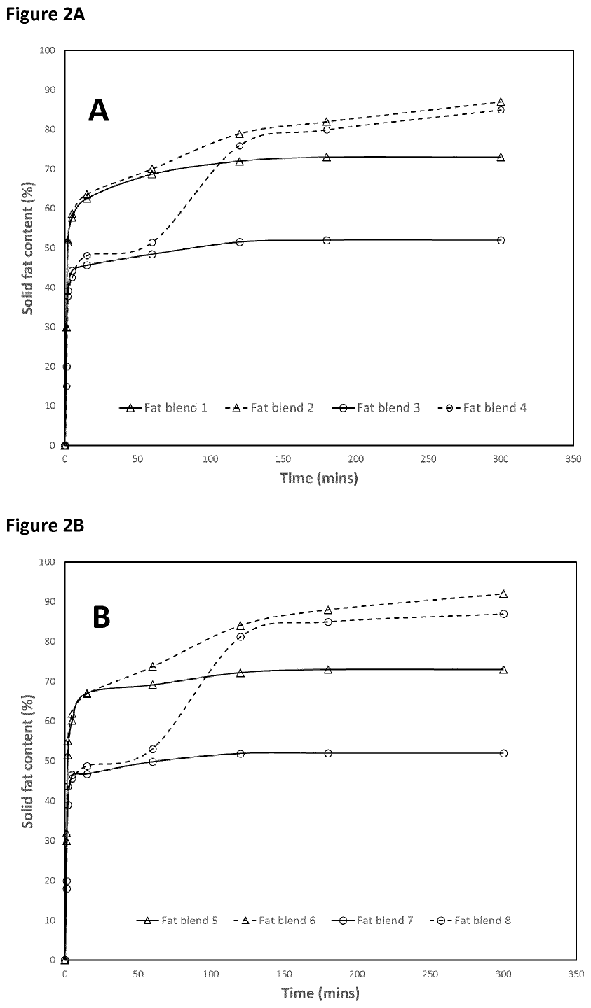

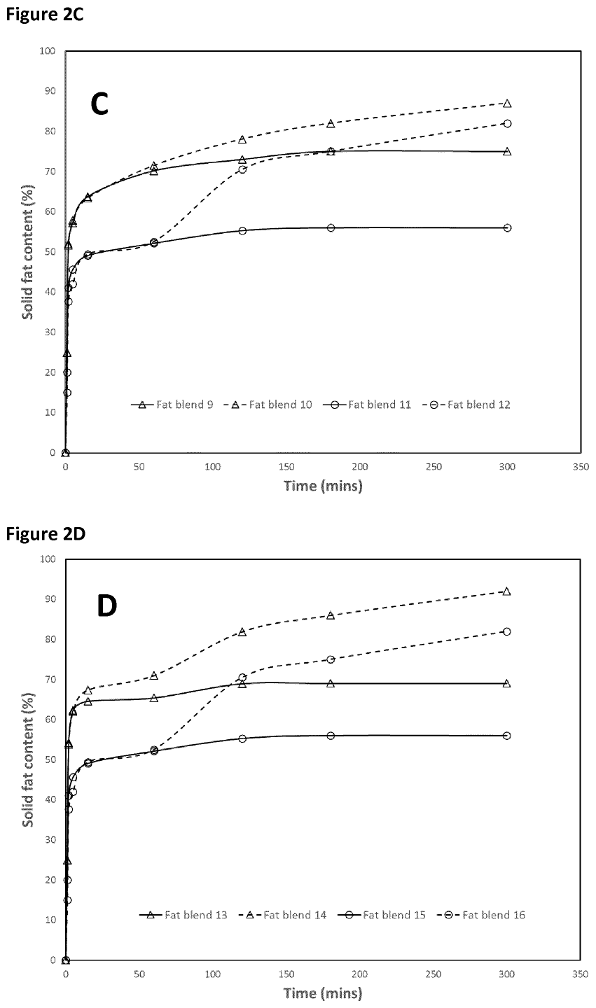

The crystallization kinetics of Fat blends 1-8 at −15° C. were evaluated and demonstrated in FIGS. 2A&B respectively. The amount of solid fat content decreased with reduced SFA for the fat blends containing sunflower oil. No increase in the solid fat profiles of the blends was found even after holding 5 h at −15° C. (Fat blend 1, 3, 5 and 7). However, surprisingly a reverse phenomenon was found when the low SFA fat blends were prepared using High oleic sunflower oil (Fat blend 2, 4, 6 and 8). Despite variation in SFA levels, fat blends containing high oleic sunflower oil displayed ‘two-step crystallization’ and were able to achieve similar solid fat content (˜80%) after holding 1 to 2 h at −15° C.

### Example 2

Medium soft fat compositions can also be prepared by blending hard palm mid fraction (e.g. Chocofill TC90) and palm olein fraction (Table 4). Blending of 48 wt. % hard palm mid fraction and 52 wt. % of palm olein fraction (Table 5, Medium soft fat C); 80% hard palm mid fraction and 20% of palm olein fraction (Table 5, Medium soft fat D) was carried out. The fatty acid compositions and IV of medium soft fat composition C and D prepared via blending is comparable to that of medium soft fat A and B respectively, which were procured as commercial fat from suppliers.

TABLE 4

| | Fatty acids (%) | | | |
|---|---|---|---|---|
| | Sat- | Mono- | Poly- | Iodine value |
| Samples | urated | unsaturated | unsaturated | (gI2/100 g) |
| Hard palm mid | 64 | 32.5 | 3.5 | 34 |
| fraction | | | | |
| Palm olein | 45 | 44 | 11 | 56 |

TABLE 5

| | Fatty acids (%) | | | |
|---|---|---|---|---|
| | Sat- | Mono- | Poly- | Iodine value |
| Samples | urated | unsaturated | unsaturated | (gI2/100 g) |
| Medium soft fat C | 54 | 38.5 | 7.5 | 45 |
| Medium soft fat D | 60 | 35 | 5 | 38 |

### Example 3

Fat compositions (Fat blend 9-16) were prepared by further blending Medium soft fat C&D (Table 5) with Sunflower oil and High oleic Sunflower oil (Table 2) as described below,

Fat blend 9=80 wt. % of Medium soft fat C+20 wt. % of Sunflower oil

Fat blend 10=80 wt. % of Medium soft fat C+20 wt. % of High Oleic Sunflower oil

Fat blend 11=59 wt. % of Medium soft fat C+41 wt. % of Sunflower oil

Fat blend 12=59 wt. % of Medium soft fat C+41 wt. % of High Oleic Sunflower oil

Fat blend 13=71 wt. % of Medium soft fat D+29 wt. % of Sunflower oil

Fat blend 14=71 wt. % of Medium soft fat D+29 wt. % of High Oleic Sunflower oil

Fat blend 15=52 wt. % of Medium soft fat D+48 wt. % of Sunflower oil

Fat blend 16=52 wt. % of Medium soft fat D+48 wt. % of High Oleic Sunflower oil

Fatty acid composition of the samples Fat blend 9-16 is summarized in Table 6.

TABLE 6

| | Fatty acids (%) | | |
|---|---|---|---|
| Samples | Saturated | Monounsaturated | Polyunsaturated |
| Fat blend 9 | 45 | 35 | 20 |
| Fat blend 10 | 45 | 47 | 8 |
| Fat blend 11 | 35 | 31 | 33 |
| Fat blend 12 | 35 | 56 | 9 |
| Fat blend 13 | 45 | 31 | 24 |
| Fat blend 14 | 45 | 48 | 7 |
| Fat blend 15 | 35 | 28 | 37 |
| Fat blend 16 | 35 | 57 | 8 |

The crystallization kinetics of Fat blends 9-16 at −15° C. were evaluated and demonstrated in FIGS. 2C&D respectively. Surprisingly similar phenomenon was found in fat blends prepared using High oleic sunflower oil (Fat blend 10, 12, 14 and 16) as described in example 1. Regardless of variation in SFA levels, the fat blends displayed ‘two-step crystallization’ and were able to achieve similar solid fat content (˜80%) after holding 1 to 2 h at −15° C. As the coating crystallization is mainly dependent on the fat composition the coating will also crystallize in a similar manner.

### Example 4

Frozen confection coating recipes (Recipe A-C) with varied fat content (40-60%) prepared at pilot plant scale have been elaborated and compositions are reported in Table 7. The compound coatings were made by first mixing the dry ingredients with part of the fat blend, this mix was then refined in a bench scale ball mill (Wieneroto Lab Mill W/1/S, Royal Duyvis Wiener B.V., The Netherlands). This refined mass was then split into 3 batches. In a Stephan mixer at 50° C. to each batch the residual fat and the lecithin was added to finish the mass to the according fat levels of the recipes A, B or C.

TABLE 7

| | Recipe | Recipe | Recipe |
|---|---|---|---|
| Ingredients | A | B | C |
| Sugar | 39.0 | 32.4 | 26.0 |
| Skimmed milk powder | 15.2 | 12.7 | 10.1 |
| Medium soft fat A | 31.6 | 39.7 | 47.7 |
| High oleic sunflower oil | 7.8 | 9.8 | 11.9 |
| Cocoa Powder (10-12% fat) | 5.9 | 4.9 | 3.9 |
| Sunflower lecithin | 0.5 | 0.5 | 0.5 |
| % Total fat | 40.8 | 50.7 | 60.5 |
| % SFA in the recipe | 18.2 | 22.7 | 27.1 |

Rheology of coatings: The rheological behaviors of different coatings at 40° C. are displayed in Table 8. The measurements confirmed that with an increasing amount of fat content in the coatings, plastic viscosity and yield stress value were reduced significantly. The particle size (D₉₀) of the coating samples as well as lecithin content (Table 7) were similar (as the recipes were prepared using same pre-refined mass) and had little effect on the rheological properties.

TABLE 8

| Samples | Plastic viscosity (Pa · s) | Yield stress (Pa) |
|---|---|---|
| Recipe A | 0.97 | 1.11 |
| Recipe B | 0.26 | 0.29 |
| Recipe C | 0.12 | 0.12 |

Physical characteristics of coatings: Comparison of coating properties between each coating recipes with varying SFA and fat content are shown in Table 9. Ice-cream sticks with surface temperature −13° C. to −15° C. was coated with the different coating recipes by dipping. The coatings were maintained at a constant temperature of 40° C. before dipping.

TABLE 9

| Samples | Pick-up weight (g) | Dripping time (s) | Setting time (s) |
|---|---|---|---|
| Recipe A | 25 | 25 | 48 |
| Recipe B | 15 | 13 | 30 |
| Recipe C | 11 | 10 | 27 |

The dripping and setting time (i.e. time required to crystallize the coatings on the frozen confection surface after dipping) and pick-up weight (i.e. amount of coating crystallized on the frozen confection surface) was found to decrease with increase in the fat content as well as SFA in the coating. With higher fat content, plastic viscosity and yield stress of coatings were found to decrease (Table 8).

The behaviors of the coating recipes A-C where found to be similar in application (dripping and setting time, and pick-up weight) and snap/cracking compared to conventional coating with similar fat content. It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A frozen confection coating composition, the composition comprising, expressed in weight % based on the total weight of the coating,
35-75 wt. % of non-interesterified fat, which comprises a fat blend of medium soft fat and liquid oil, and
25-65 wt. % of non-fat solids,
wherein, the coating composition comprises,
less than 35 wt. % of saturated fatty acid,
15-50 wt. % of monounsaturated fatty acid and
less than 10% of polyunsaturated fatty acid, and
wherein the medium soft fat has above 40% of solid fat content at 20° C., and medium soft fat has 54-60% of saturated fatty acid, and
wherein the fat blend in the coating crystallizes in a first and second crystallization step at a temperature below −15° C. and displays a solid fat content of 30-50% within 2 min. of crystallization and a solid fat content of 40-70% after 60 min. of crystallization.

2. A composition according to claim 1, wherein the fat blend of medium soft and liquid oil comprises 40-80 wt % of medium soft fat and 20-60 wt. % of liquid oil based on the weight of the total fat blend.

3. A composition according to claim 1, wherein the fat blend of medium soft fat and liquid oil comprises 50-80 wt. % of medium soft fat, and 20-50 wt. % of liquid fat, based on the weight of the total fat blend.

4. A composition according to claim 1, wherein the composition further comprise a structuring agent in an amount sufficient to provide strength and faster crystallization kinetic properties to the coating, wherein the structuring agent is an agent selected from the group consisting of: monoacylglycerol, diacylglycerol, monoacylglycerol ester, sorbitan fatty acid ester, waxes, behenic acid, palm stearin, and sucrose ester and combinations thereof.

5. A composition according to claim 1, wherein the structuring agent is present in an amount of between about 0.2% and 3% by weight of the coating.

6. A composition according to claim 1, wherein the medium soft fat is selected from the group consisting of: Palm oil fractions, Shea butter fractions, Kokum Butter fractions, Sal Butter fractions, Cocoa Butter fractions where it includes soft stearin, mid and olein fractions or a combination and combinations thereof.

7. A coating composition according to claim 1, wherein the medium soft fat is medium soft palm mid fraction comprising:
50-60 wt. %, preferably 54-60 wt. % of saturated fatty acid;
C16 fatty acids which amount to more than 40% of the total fatty acids of the medium soft fat;
displays above 40%, preferably between 50-70%, of solid fat content at 20° C.;
a melting point between 28-32° C.; and
an iodine value (IV) of 36-48.

8. A composition according to claim 1, wherein the liquid oil is selected from the group consisting of: high oleic sunflower oil, high stearic high oleic sunflower oil, high oleic safflower oil, high oleic soybean oil, high oleic rapeseed oil such as high oleic canola oil, high oleic algal oil, high oleic palm oil, high oleic peanut oil, olive oil, macademia nut oil, moringa oleifera seed oil, hazelnut oil, avocado oil and combinations thereof.

9. A composition according to claim 8, wherein the liquid oil is high oleic sunflower oil or high oleic soybean comprising
a) above 70% of monounsaturated fatty acid
b) below 10% of polyunsaturated fatty acid
c) displays below 5% of solid fat content at 0° C.,
wherein, the unsaturated fatty acid contains 16C-atoms or more.

10. A composition according to claim 1, wherein the non-fat solids are selected from the group consisting of: sugar, fibres, cocoa powder, milk powder, emulsifier and one or more flavours.

11. A composition according to claim 1, wherein the composition comprises 0.1-2 wt. % of emulsifiers selected from the group consisting of sunflower lecithin, soya lecithin polyglycerol polyricinoleate (PGPR; E476), ammonium phosphatide (YN; E442) and combinations thereof.

12. A composition according to claim 1, wherein comprising
35-75 wt. % fat comprising a blend of
15-60 wt. % medium soft and
5-40 wt. % liquid oil, and
20-40 wt. % sugar,
0-20 wt. % cocoa powder, and
0-20 wt. % of non-fat milk solids.

13. A process for manufacturing a coating composition, wherein the process comprising the steps:
providing non-fat solids, medium soft fat and liquid oil,
melting the medium soft fat;
mixing non-fat solids with the at least part of the melted medium soft fat and
obtaining a mixture of medium soft fat and non-fat solids,
refining the mixture of medium soft fat and non-fat solids by milling to reduce the size of particles to a particle size to below 40 microns,
adding the liquid oil to the refined mixture; and
adding emulsifier to the refined mixture and/or the mixture with the liquid oil.

14. A process for producing an at least partly coated frozen confection, the process comprising: providing a coating composition comprising, expressed in weight % based on the total weight of the coating, 35-75 wt. % of non-interesterified fat, which comprises a fat blend of medium soft fat and liquid oil, and 25-65 wt. % of non-fat solids, wherein, the coating composition comprises, less than 35 wt. % of saturated fatty acid, 15-50 wt. % of monounsaturated fatty acid and less than 10% of polyunsaturated fatty acid, and wherein the medium soft fat has above 40% of solid fat content at 20° C., and medium soft fat has 54-60% of saturated fatty acid, and wherein the fat blend in the coating crystallizes in a first and second crystallization step at a temperature below −15° C. and displays a solid fat content of 30-50% within 2 min. of crystallization and a solid fat content of 40-70% after 60 min. of crystallization; and coating a frozen composition.

15. (canceled)
